(19) United States
(12) Patent Application Publication
(10) Pub. No.: US 2010/0248578 A1
(43) Pub. Date: Sep. 30, 2010

(54) DISPLAY PANEL AND MANUFACTURING METHOD THEREOF

(76) Inventors: Ji-Won CHOI, Seoul (KR); Byoung-Joo Kim, Anyang-si (KR); Gug Rae Jo, Cheonan-si (KR); Jin-Kyung Choi, Seoul (KR)

Correspondence Address: Innovation Counsel LLP, 21771 Stevens Creek Blvd, Ste. 200A, Cupertino, CA, 95014, US

(21) Appl. No.: 12/815,175

(22) Filed: Jun. 14, 2010

Related U.S. Application Data
(62) Division of application No. 11/539,336, filed on Oct. 6, 2006.

(30) Foreign Application Priority Data
Oct. 7, 2005 (KR) 10-2005-0094334

(51) Int. Cl. H01J 9/00

(52) U.S. Cl. 445/24

(57) ABSTRACT

A display panel includes a base substrate, a first linear pattern on the base substrate along a first direction and a second linear pattern on the first linear pattern along a second direction crossing the first direction. The display panel further includes a color filter layer on the first linear pattern and an overcoat layer on the second linear pattern. The color filter layer includes a number of color filter patterns disposed along the first direction. The first direction is perpendicular to the second direction. The invention also discloses a fabrication method of the display panel. The method includes forming the first linear pattern and forming the second linear pattern. Here, a gravure printing forms the first and the second linear patterns. The fabrication method further includes forming the color filter layer. The method further includes flattening the color filter layer and forming an overcoat layer on the second linear pattern.

The present invention is a divisional of U.S. patent application Ser. No. 11/539,336 filed on Oct. 6, 2006, which claims Paris Convention priority of South Korean patent application No. 10-2005-0094334 filed on Oct. 7, 2005, the entire contents of which are incorporated herein by reference.

### BACKGROUND OF THE INVENTION

(a) Field of the Invention

The present invention relates to a display panel and a manufacturing method thereof, and in particular, to a display panel and a manufacturing method thereof using a gravure printing method.

(b) Description of Related Art

A liquid crystal display (LCD) is one of the most widely used flat panel display types. An LCD includes two panels provided with field-generating electrodes such as pixel electrodes and a common electrode, and a liquid crystal (LC) layer interposed therebetween. The LCD displays images by applying voltages to the field-generating electrodes to generate an electric field in the LC layer, which determines orientations of LC molecules in the LC layer to adjust polarization of incident light.

One of the two panels of the LCD generally includes a patterned color filter layer and a patterned black matrix layer. The color filter layer and the black matrix layer are formed by a photolithography method.

However, the patterning by photography includes a series of processes, such as a photo-resist deposition process, an exposing process, a developing process and a cleaning process.

Recently, as alternatives to the photolithography, inkjet printing and gravure printing have been developed.

In particular, gravure printing includes filling ink in the gravure pattern of a substrate, transferring the ink onto the surface of a printing roller and transferring the ink onto another substrate.

Gravure printing generally has good reproducibility in printing island type patterns in which all patterns are separate one another, or in printing parallel linear type patterns whose longitudinal directions are parallel with the printing direction.

However, the gravure printing does not have a good reproducibility in printing vertical linear type patterns whose longitudinal direction is perpendicular to the printing direction. Referring to FIG. 1, the printing direction of a printing roller 91 is perpendicular to the longitudinal directions of grooves 93 on a printing plate 92. When the ink filled in grooves 93 is transferred onto a transfer sheet (not shown) on a printing roller 91, a portion of the ink tends to remain in the corners of grooves 93. Because the quantities of the remaining portion of the ink are likely to vary at each printing, the printing reproducibility becomes poor.

On the other hand, in case of printing parallel linear type patterns whose longitudinal directions are parallel with the printing direction, as there are no walls in the printing direction, the ink filled in the grooves can be transferred onto the transfer sheet on the printing roller without remaining portion, thereby the printing reproducibility becomes good. Also, in case of printing island type patterns, the printing reproducibility is good.

The black matrix layer often has the vertical linear type patterns. Therefore, the printing reproducibility is poor.

### SUMMARY OF THE INVENTION

In accordance with an embodiment of the present invention, a display panel includes a base substrate, a first linear pattern on the base substrate along a first direction and a second linear pattern on the first linear pattern along a second direction crossing the first direction. The display panel further includes a color filter layer on the first linear pattern and an overcoat layer on the second linear pattern. The color filter layer, which is formed between the first linear pattern and the second linear pattern, includes a number of color filter patterns that are disposed along the first direction. The first direction is perpendicular to the second direction.

Another embodiment of the invention is directed to fabrication method of a display panel. The method includes forming a first linear pattern on a base substrate along a first direction and forming a second linear pattern on the first linear pattern along a second direction crossing the first direction. Here, a gravure printing forms the first and the second linear patterns. The fabrication method further includes forming a color filter layer on the first linear pattern. The color filter layer includes a number of color filter patterns formed along the first direction. The color filter layer is formed between the first linear pattern and the second linear pattern. The method further includes flattening the color filter layer and forming an overcoat layer on the second linear pattern. The first direction is perpendicular to the second direction.

### BRIEF DESCRIPTION OF THE DRAWINGS

FIG. 1 illustrates a prior art printing method.

FIG. 2 is a perspective view of a display panel according to an embodiment of the present invention.

FIG. 3 is a sectional view of the display panel of FIG. 2.

FIG. 4 is a perspective view of the display panel of FIG. 2 having a pattern of a black matrix according to an embodiment of the present invention.

FIGS. 5-9 illustrate a manufacturing method of the display panel of FIG. 4.

FIG. 10 is a perspective view of a display panel according to another embodiment of the present invention.

FIGS. 11-15 illustrate a manufacturing method of the display panel of FIG. 10.

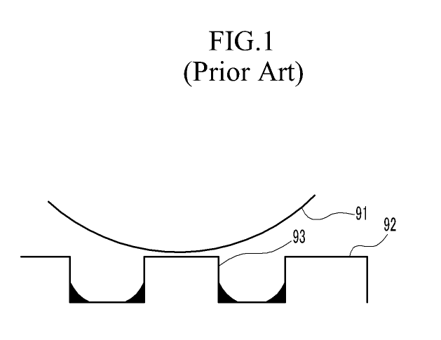

Use of the same reference symbols in different figures indicates similar or identical items.

### DETAILED DESCRIPTION OF EMBODIMENTS

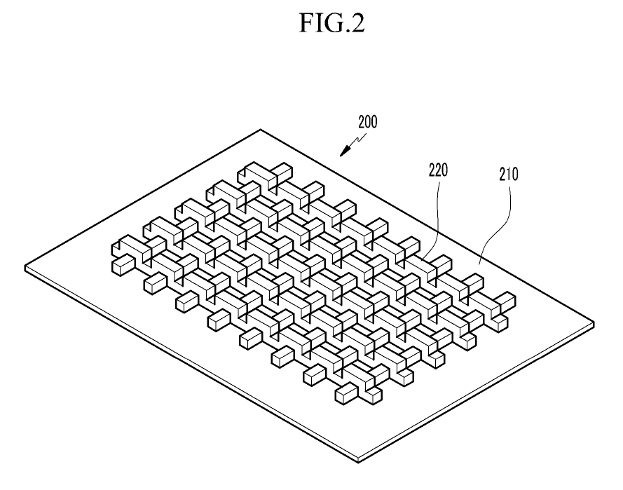

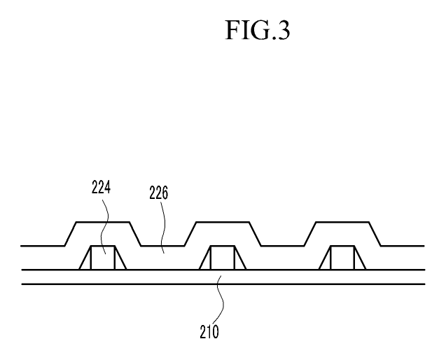

A display panel according to an embodiment of the present invention will be described in detail with reference to FIGS. 2 and 3.

FIG. 2 is a perspective view of a display panel 200 according to an embodiment of the invention, and FIG. 3 is a sectional view of the display panel 200 of FIG. 2.

As described in FIGS. 2 and 3, the display panel 200 includes a base substrate 210, which is often a transparent glass or plastic panel, and a black matrix 220 disposed on the base substrate 210. The black matrix 220 includes two layers of linear patterns crossing each other, one of which is a first linear pattern 224, and the other of which is a second linear pattern 226 crossing the first linear pattern 226. The black matrix 220 is typically formed of a plastic layer including a light-blocking material such as carbon black. The display panel 200 can be used for an LCD or an organic light emitting display (OLED).

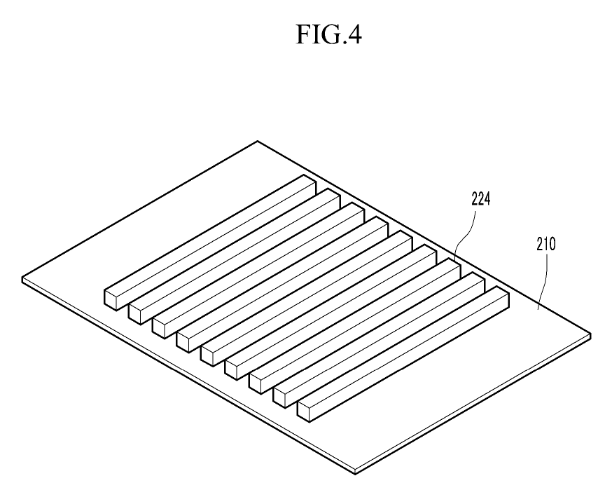

FIGS. 4-9 illustrate a printing method of the black matrix 220.

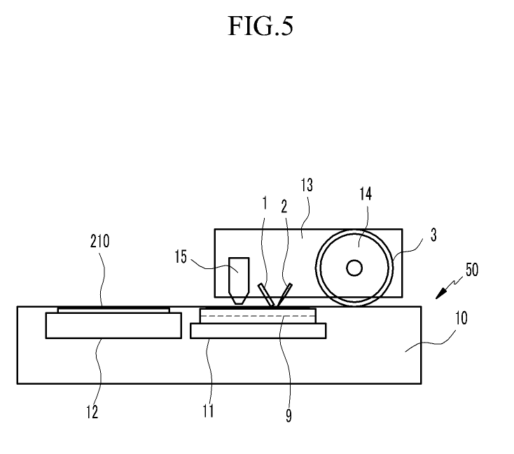

Referring to FIG. 4, the first linear pattern 224 of the black matrix 220 is formed on the base substrate 210 by using a printing system 50 (shown in FIG. 5). The longitudinal direction of the first linear pattern 224 is in parallel with the printing direction.

Referring to FIG. 5, the printing system 50 includes a supporting base 10 and a printing unit 13. Supporting base 10 includes two surface plates 11 and 12. The base substrate 210 is disposed on the surface plate 12, and a printing plate 9 is disposed on the surface plate 11. The printing unit 13, which includes a printing roller 14, blades 1 and 2, and dispenser 15, is disposed over the supporting base 10. A transfer sheet 3 is attached on the surface of the printing roller 14.

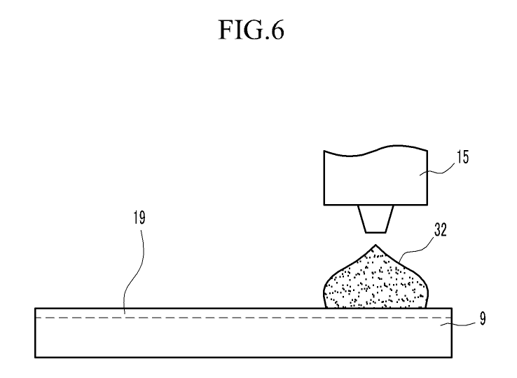

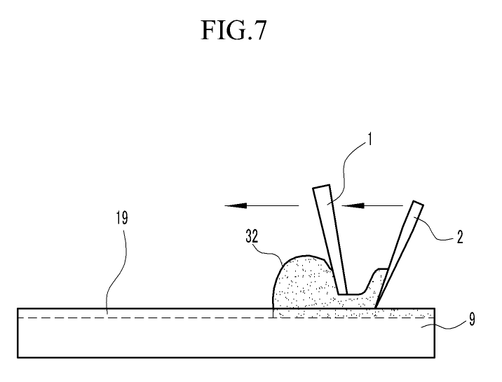

Referring to FIGS. 6 and 7, a chunk of black matrix material 32 is disposed on the printing plate 9 from the dispenser 15. Then, the front blade 1 advances so that the black matrix material 32 fills into grooves 19, the longitudinal direction of which is in parallel with the advancing direction of the blade 1. The rear blade 2 follows the front blade 1 and scrapes the printing plate 9, such that the black matrix material 32 remains only in the grooves 19 to form a pattern 320 corresponding to the grooves 19.

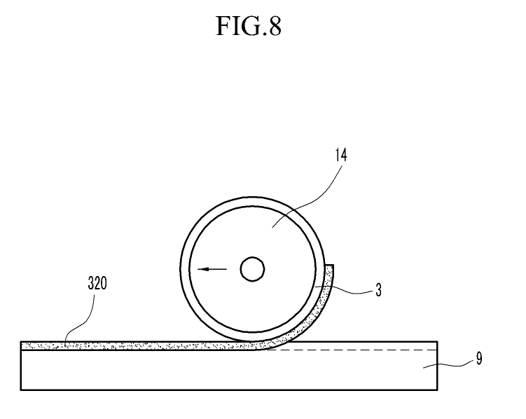

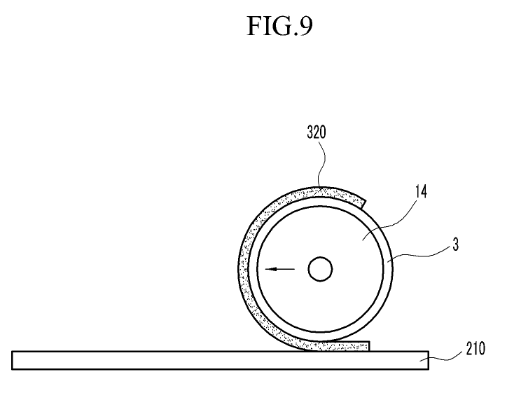

Referring to FIGS. 8 and 9, the pattern 320 is transferred onto the transfer sheet 3 on the printing roller 14, which follows the blades 1 and 2.

Then, the pattern 320 on the transfer sheet 3 is transferred onto the base substrate 210 to form the first linear pattern 224 of FIG. 4

Next, the base substrate 210 is turned around at a right angle, and the second linear pattern 226 of FIG. 3 is formed on the first linear pattern 224 in a similar way that the first linear pattern 224 was formed. Accordingly, the black matrix 220 of FIG. 2 is completed.

The printed structure described in FIGS. 2 to 9 can be used for the black matrix layer of an LCD or a bank structure of an OLED.

According to the present embodiment, because both longitudinal directions of the first linear pattern 224 and the second linear pattern 226 are in parallel with the printing direction, the patterning material filled in the grooves 19 can be transferred onto the transfer sheet 3 of the printing roller without a remaining portion. As a result, the printing reproducibility is good.

However, where the first linear pattern 224 and the second linear pattern 226 overlaps, the first linear pattern 224 may deform due to the stresses produced during the printing of the second linear pattern 226, or the second pattern 226 may be disconnected due to the first linear pattern 224 underneath. Also, where the first linear pattern 224 and the second linear pattern 226 overlaps, voids 230 can be produced because of the step coverage problem.

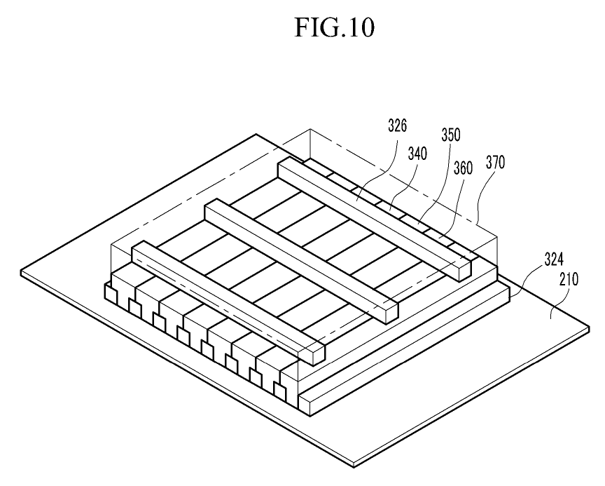

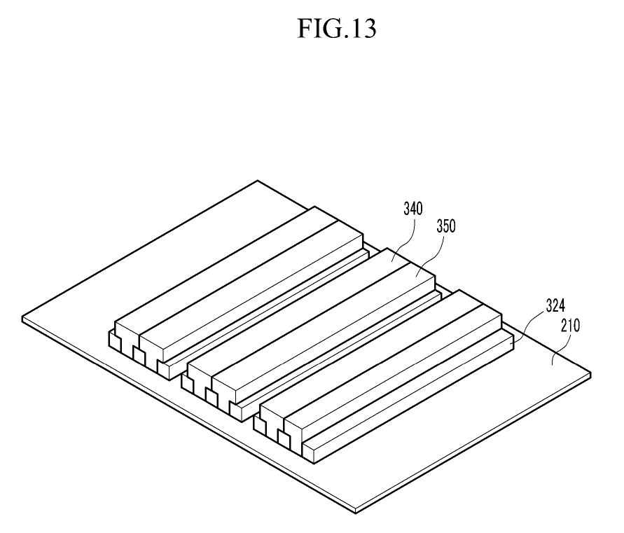

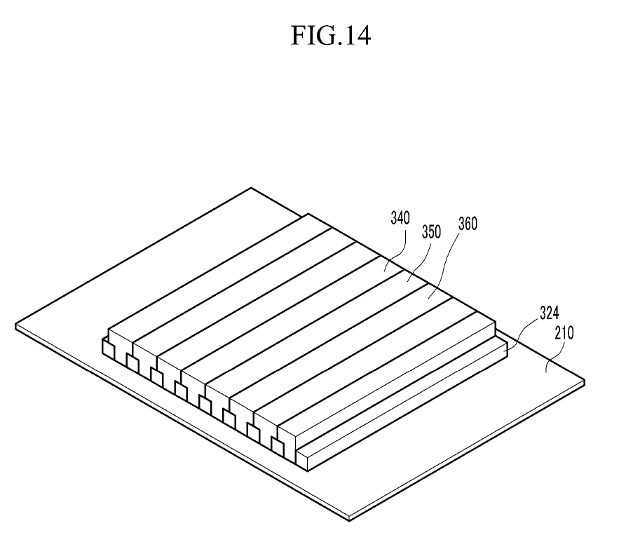

Thus, another embodiment of the present invention to resolve aforementioned problems will be described with FIGS. 10-15.

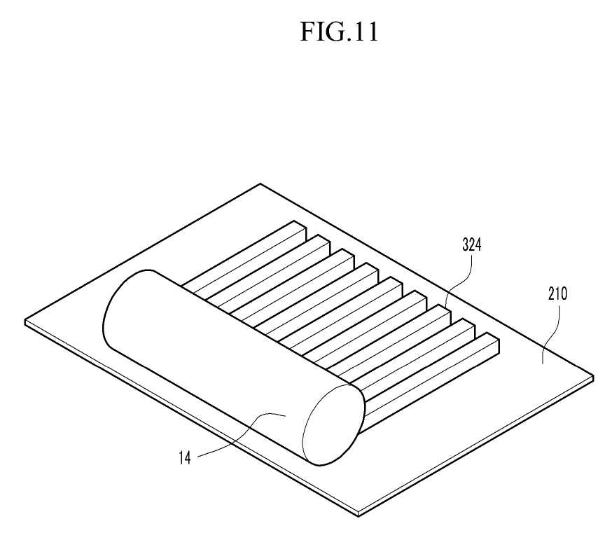

FIG. 10 is a perspective view of a display panel 300 according to another embodiment of the present invention. FIGS. 11-15 illustrate a fabricating method of the display panel 300.

Referring to FIG. 10, the display panel 300 includes a base substrate 210, a first linear pattern 324, color filters 340, 350 and 360, a second linear pattern 326, and an overcoat layer 370.

Referring to FIG. 11, the first linear pattern 324 is formed on the base substrate 210 in the same manner as the first linear pattern 224 of FIG. 4. After printed on the base substrate 210, the first linear pattern 324 can be cured.

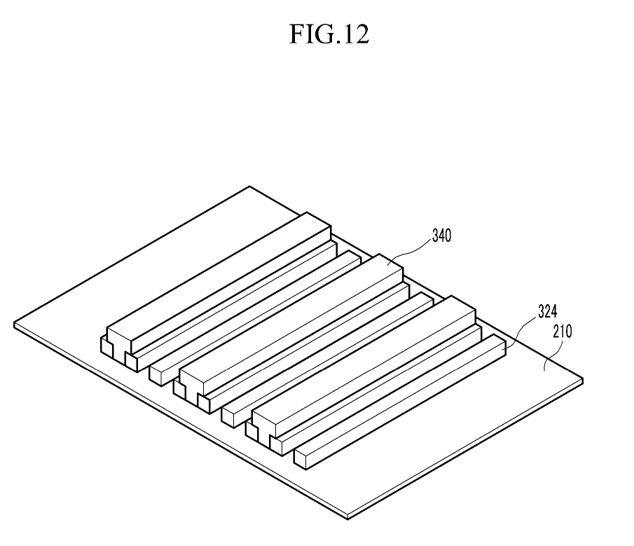

Next, as shown in FIGS. 12-14, linear type R, G and B color filter patterns 340, 350 and 360 are sequentially printed in the same manner as the first linear pattern 324. The longitudinal directions of the color filters 340, 350 and 360 are substantially the same as the longitudinal direction of the first linear pattern 324, and the edges of the color filters 340, 350 and 360 are met one another. The color filter patterns 340, 350 and 360 are also can be cured one by one or simultaneously. At this time, if the surface of the color filter patterns 340, 350 and 360 is not uniformly flat because of the first linear pattern 324, a flattening process through which the surface of the color filters 340, 350 and 360 are flattened by a roller (not shown) may be added before the curing process.

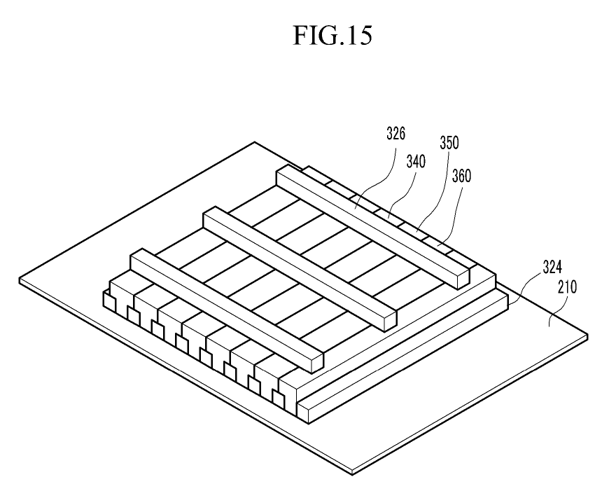

Then, as shown in FIG. 15, the base substrate 210 is turned around at a right angle, and a second linear pattern 326 is formed on the color filter patterns 340, 350 and 360 in the same manner as the first linear pattern 324. Curing process may be added further, if needed.

Finally, the overcoat layer 370 is formed over the color filter patterns 340, 350 and 360 and the second linear pattern 326.

In this embodiment, the second linear pattern 326 is formed on a flat surface, so that the potential problems associated with the previous embodiment can be eliminated.

The above-described embodiments of the present invention are merely meant to be illustrative and not limiting. It will thus be obvious to those skilled in the art that various changes and modifications may be made without departing from this invention in its broader aspects. Therefore, the appended claims encompass all such changes and modifications as fall within the true spirit and scope of this invention.

What is claimed is:

1. A fabrication method of a display panel comprising:
forming a first linear pattern on a base substrate along a first direction; and
forming a second linear pattern on the first linear pattern along a second direction crossing the first direction,
wherein the first linear pattern and the second linear pattern are formed by a gravure printing.

2. The fabrication method of claim 1, further comprising forming a color filter layer on the first linear pattern.

3. The fabrication method of claim 2, wherein the color filter layer comprises a plurality of color filter patterns.

4. The fabrication method of claim 3, wherein the color filter patterns are formed along the first direction.

5. The fabrication method of claim 2, wherein the color filter layer is formed between the first linear pattern and the second linear pattern.

6. The fabrication method of claim 5, further comprising flattening the color filter layer.

7. The fabrication method of claim 6, further comprising forming an overcoat layer on the second linear pattern.

8. The fabrication method of claim 1, wherein the first direction is perpendicular to the second direction.
